(19) United States
(12) Patent Application Publication
(10) Pub. No.: US 2016/0243826 A1
(43) Pub. Date: Aug. 25, 2016

(54) METHOD FOR DETERMINING FUNCTIONING OF A PRINT HEAD COOLER

(71) Applicant: OCE-TECHNOLOGIES B.V., Venlo (NL)

(72) Inventors: Lambertus M.L. Van Sas, Venlo (NL); Cornelis J. Groenenberg, Venlo (NL)

(73) Assignee: OCE-TECHNOLOGIES B.V., Venlo (NL)

(21) Appl. No.: 15/143,045

(22) Filed: Apr. 29, 2016

Related U.S. Application Data
(63) Continuation of application No. PCT/EP2014/073370, filed on Oct. 30, 2014.

(30) Foreign Application Priority Data
Nov. 1, 2013 (EP) 13191298.2

(51) Int. Cl. B41J 2/045; B41J 29/377

(52) U.S. Cl. CPC B41J 2/04563; B41J 29/377; B41J 2/04586

(57) ABSTRACT

A method for determining functioning of a print head cooler includes operating the print head cooler, the print head cooler including a first surface in thermal contact with a surface of a print head; providing a predetermined amount of heat to the print head; measuring the temperature of the print head; based on the measured temperature, determining the functioning of the print head cooler. The predetermined amount of heat is provided by applying at least one non-jetting pulse to a liquid present in the print head. An assembly of a print head and a print head cooler is also disclosed. The assembly includes a control that is configured to perform the method for determining functioning of a print head cooler.

### CROSS-REFERENCE TO RELATED APPLICATIONS

This application is a Continuation of International Application No. PCT/EP2014/073370, filed on Oct. 30, 2014, and for which priority is claimed under 35 U.S.C. §120. PCT/EP2014/073370 claims priority under 35 U.S.C. §119(a) to Application No. 13191298.2, filed in Europe on Nov. 1, 2013. The entire contents of each of the above-identified applications are hereby incorporated by reference into the present application.

### BACKGROUND OF THE PRESENT INVENTION

1. Field of the Invention

The present invention relates to a method for determining functioning of a print head cooler. The present invention further relates to an assembly of a print head and a print head cooler, the assembly further comprising a control unit configured to perform said method.

2. Description of Background Art

In ink jet printers comprising a print head, the properties of the fluid to be ejected (e.g. ink) as well as the properties of the print head may depend on the temperature of the print head and the fluid inside the print head. Hence, the temperature may influence the stability of the jetting process and consequently, the temperature may influence the print quality.

To maintain the desired properties of the fluid and the print head during operation of the ink jet printer, the temperature of the print head is controlled. The temperature of the print head may be controlled, e.g. by using a print head cooler configured to cool the print head and the fluid inside the print head. When the proper functioning of the print head depends on its temperature, then it is important to be sure that the print head cooler functions properly. The functioning of the print head cooler may be assessed by investigating the cooling capacity of the cooler. However, for performing such investigation, the cooler may have to be removed from the printer to be investigated. Removing the cooler from the print head and putting it back in the printer is time consuming and may therefore decrease the productivity of the printer.

### SUMMARY OF THE INVENTION

It is therefore an object of the present invention to provide a method for determining functioning of a print head cooler without substantially decreasing productivity of the printer.

In addition, it is an object of the present invention to provide a method for determining functioning of a print head without polluting the printer.

The object of the present invention is achieved in a method for determining functioning of a print head cooler, the method comprising the steps of:
a. operating the print head cooler, the print head cooler comprising a first surface in thermal contact with a surface of a print head;
b. providing a predetermined amount of heat to the print head;
c. measure the temperature T of the print head; and
d. based on the measured temperature T, determining the functioning of the print head cooler,
wherein the predetermined amount of heat is provided by applying at least one non-jetting pulse to a liquid present in the print head.

In an inkjet printer, droplets of ink may be applied onto a receiving medium by a print head. The print head may eject droplets, and by applying a predetermined pattern of droplets onto the receiving medium, an image may be formed. Several types of print heads are known, of which piezo-electric print heads and thermal print heads are the most common ones. For both types of print heads, energy has to be provided to the print head to eject a droplet of ink. Part of the energy provided may be converted into kinetic energy of the droplet, but another part may be converted into thermal energy. The thermal energy generated upon operating the print head may result in a temperature increase of the print head. Change in temperature of the print head is undesired, since parameters of the jetting process, such as viscosity of the ink, properties of a piezo-electric element, etc. may be temperature dependent. To keep the temperature constant, a print head may be provided with a print head cooler. The print head cooler may be in thermal contact with the print head. The print head cooler may comprise a first surface. The first surface may be in thermal contact with a surface of the print head. When heat is generated in the print head, for example by energy dissipation of a moving fluid in the print head interior, the temperature of the print head may increase. This provides a driving force for transferring thermal energy from the print head to the print head cooler.

The print head cooler may be any suitable cooler. For example, the print head cooler may be configured to remove thermal energy from the print head using a cooling liquid. Any suitable cooling liquid may be used, for example water, buffered water, glycerol, alcohols or mixtures thereof. Alternatively, a gas, such as air, may be used to cool the print head. The print head cooler may comprise a thermally conductive material, such as a metal. Preferably, at least a surface of the print head cooler in thermal contact with the printer is made of a thermally conductive material, thereby allowing efficient heat transfer between the print head and the print head cooler. In addition, the shape of the print head cooler may be adapted to the shape of the print head to allow a sufficient contact surface between the print head and the print head cooler, thereby allowing good transfer of heat between the print head and the print head cooler. Optionally, the print head cooler may comprise a surface having a flexible shape, to allow optimal contact between the print head and the print head cooler.

When the print head cooler is functioning properly, the print head cooler may, in operation, keep the temperature of the print head within a predetermined temperature range. However, if the print head cooler does not function properly, then it may not prevent a temperature increase of the print head. Alternatively, if the print head cooler cools too much, then the temperature of the print head may decrease to a temperature below the predetermined temperature range.

In step a) of the method, the print head cooler is operated. For example, if the print head cooler is a cooler using a cooling liquid, then cooling liquid may flow through the print head cooler. When the print head cooler is operated, the print head cooler may remove an amount of heat from the print head and the fluid, such as ink, contained in the print head. The removal of heat by the print head cooler may influence the temperature of the print head. Please note that the amount of heat removed by the print head cooler may be zero. This may happen, e.g. when the print head cooler does not function at all, for example if a flow channel of cooling liquid is blocked.

In step b), a predetermined amount of heat is provided to the print head. The predetermined amount of heat is provided by applying at least one non jetting pulse to a liquid present in the print head. The actuator of a print head may provide pulses for jetting a droplet of fluid. These pulses may be used to provide an image onto a receiving medium. In addition, the actuator of the print head may provide a non jetting pulse. A non jetting pulse may be a pulse configured to not eject a droplet of the fluid. When applying a non jetting pulse to the fluid, a motion may take place within the fluid. For example, the meniscus of the fluid, which is positioned in or in proximity of the nozzle, may be vibrated upon applying a non jetting pulse. Since the non jetting pulse is configured to not eject a droplet of ink, no ink may be provided to the print head environment when applying a non jetting pulse. Hence, the print head environment may not be polluted when applying a non jetting pulse. For example, no ink droplets may be provided to a receiving medium in proximity of the print head. Moreover, surrounding parts of the printing apparatus, e.g. other print heads, may not be polluted when applying a non-jetting pulse. Consequently, the print head does not need to be removed from the printing apparatus to determine functioning of the print head cooler.

The motion generated in the fluid by applying the non-jetting pulse generates an amount of heat in the fluid. For example, friction may result in damping of the motion and kinetic energy may be converted into thermal energy (heat). In addition, heat may be generated in the actuator when applying a non-jetting pulse.

The heat generated in the fluid may result in heating of the fluid, which may result in heating of the print head. The non jetting pulse may provide a predetermined amount of heat to the print head and the fluid in the print head. The thermal properties of the print head and the fluid may be known.

The non-jetting pulse may be provided using the actuator of the print head. For example, the actuator may comprise a piezoelectric element. The print head may be provided with an actuator to eject droplets. Hence, no additional heater may be required to apply the method according to the present invention.

In step c), the temperature T of the print head is measured. The temperature may be measured using a suitable temperature measuring device. For example, the temperature may be measured using a thermometer or a thermo-couple. Alternatively, the temperature of the print head may be measured using a pyrometer.

In step d), the functioning of the print head cooler is determined, based on the measured temperature T.

The predetermined amount of heat, provided in step b), may result in a temperature increase of the print head. The actual increase in temperature may depend on the amount of heat supplied to the print head as well as on the amount of heat removed from the print head by cooling. Since the amount of heat provided to the print head is a predetermined amount of heat, the temperature increase of the print head provides information of the amount of heat removed by cooling of the print head and hence, provides information on the functioning of the print head cooler.

The measured temperature T of the print head may be compared to at least one reference temperature T_{ref}. The at least one reference temperature T_{ref} may be suitably selected. For example, T_{ref} may be the temperature of the print head after applying a predetermined amount of heat to the print head while not actively cooling the print head, for example by turning off the print head cooler. In this case, if the measured temperature T is lower than the reference temperature T_{ref}, it may be concluded that the print head cooler is at least partially functioning.

Alternatively, or additionally, T_{ref} may be the temperature of the print head in operation, wherein the print head is provided with a fully functioning print head cooler. In this case, if the measured temperature T is higher than the reference temperature T_{ref}, it may be concluded that the print head cooler is not fully functioning.

The measured temperature T may be compared to more than one reference temperature in order to determine to what extent the print head cooler is functioning. The temperature of the print head after applying the predetermined amount of heat may be measured at one position or at a plurality of positions. In the latter case, each of the measured temperatures at the plurality of positions may be compared to at least one reference temperature T_{ref} in order to determine whether a print head cooler is locally functioning.

In an embodiment, in step d) the functioning of the print head cooler is determined by comparing the measured temperature T with a plurality of reference temperatures.

The plurality of reference temperatures may comprise a number of reference temperatures. An example of a plurality of reference temperatures is a series of reference temperatures comprising a maximum temperature T_{ref max}, a high temperature T_{ref high} and a low temperature T_{ref low}, wherein T_{ref low}<T_{ref high}<T_{ref max}. The maximum temperature T_{ref max} may be a temperature of a print head that has been provided with the predetermined amount of heat, but has not been cooled. Hence, when in step c), the measured temperature T equals T_{ref max}, it may be concluded in step d) that the print head cooler does not function at all.

The high temperature T_{ref high} may be the maximum temperature at which the print head is able to function properly. The low temperature T_{ref low} may be the minimum temperature at which the print head is able to function properly. Hence, when in step c), a temperature in between T_{ref low} and T_{ref high} is detected, it may be concluded in step d) that the print head cooler is functioning properly. If in step c), the measured temperature T below T_{ref} then in step d) it may be concluded that the print head cooler is malfunctioning in the sense that it cools too much. This may occur, e.g. in a situation where the print head cooler uses a cooling liquid and the temperature of the cooling liquid is too low.

When the temperature T, measured in step c) is in between T_{ref high} and T_{ref max}, then it may be determined in step d) that the print head cooler is not fully functioning.

In an embodiment, the print head cooler is operated for a first predetermined amount of time Δt₁. The amount of heat removed from the print head by the print head cooler may depend on the amount of time the print head cooler is operated; the longer the print head cooler is operated, the more heat may be removed. The amount of heat removed from the print head may influence the temperature of the print head. Therefore, the print head cooler may be operated for a first predetermined amount of time Δt₁ in order to properly determine the function of the print head.

In an embodiment, the temperature T of the print head is measured a second predetermined amount of time Δt₂ after applying the predetermined amount of heat. The predetermined amount of heat may be locally applied to the print head or the fluid in the print head. Without wanting to be bound to any theory, it is believed that the temperature may not increase homogeneously throughout the print head. By waiting a second predetermined amount of time Δt₂ after applying the predetermined amount of heat, the heat may dissipate throughout the print head and the temperature may become more uniform throughout the print head.

In an embodiment, the temperature of the print head is measured at least twice (during the predetermined amount of time Δt).

If more than one measurement is performed, the functioning of the print head may be determined more accurately. For example, the temperature of the print head may be measured at different time intervals. In that case, the temperature of the print head may be monitored as a function of time.

The temperature T of the print head may be determined at a plurality of positions in the print head. By determining the temperature T at different positions, local malfunction of the print head cooler may be detected. When measuring the temperature T at a plurality of positions, the temperature T may be measured once at each of the plurality of positions or may be measured a plurality of times. Alternatively, in at least one of the plurality of positions, the temperature T may be measured once and in at least another one of the plurality of positions, the temperature T may be measured a plurality of times.

In an embodiment, the print head cooler further comprises a second surface and a cooling liquid channel provided between the first surface and the second surface for flowing cooling liquid.

The first surface of the print head cooler may be in contact with the print head. Via this first surface, the print head cooler and the print head may be in thermally conductive contact; heat may flow from the print head to the print head cooler to remove heat from the print head, thereby lowering the temperature of the print head. The print head cooler may further comprise a second surface. The second surface may or may not be in contact with a surface of the print head. In between the first and the second surfaces of the print head cooler, a cooling liquid channel may be provided. The cooling liquid channel may be configured to contain a cooling liquid and to flow the cooling liquid. The cooling liquid may comprise, e.g. water, an aqueous solution, such as an aqueous salt solution, an organic solvent or a mixture of water and an organic solvent, such as glycol. Flowing the cooling liquid is an efficient way of cooling an object, such as a print head. The cooling liquid channel may be provided with a cooling liquid inlet and a cooling liquid outlet. Via the cooling liquid inlet and the cooling liquid outlet, the cooling liquid channel may be in communication with a cooling liquid reservoir.

In a further embodiment, the temperature of the cooling liquid and the flow rate of the cooling liquid are controlled.

The amount of heat removed by a print head cooler using a cooling liquid, may depend, e.g. on the flow rate of the cooling liquid as well as on the temperature of the cooling liquid. The higher the flow rate of the cooling liquid, the more heat may be removed from the print head. The lower the temperature of the cooling liquid, the more heat may be removed from the print head. Thus, the function of the print head cooling may depend on the flow rate and the temperature of the cooling liquid. Hence, the temperature T measured when performing the method according to the present invention may depend on the flow rate and temperature of the cooling liquid. Therefore, the temperature of the cooling liquid and/or the flow rate of the cooling liquid may be controlled.

In a further aspect of the present invention, an assembly of a print head and a print head cooler is provided, the print head comprising an ink chamber configured to contain an amount of ink, and an actuator configured to apply a non jetting pulse to the ink in the fluid chamber, the print head cooler comprising a first surface that in operation is in thermal contact with a surface of a print head, wherein the assembly further comprises a temperature measuring device configured to measure the temperature of the print head and wherein the assembly further comprises a controller for performing a method according to the present invention.

Hence, the assembly of a print head and a print head cooler in accordance with the present invention is configured to perform the method according to the present invention.

The temperature measuring device may be a conventional temperature measuring device. Known, non-limiting examples of temperature measuring devices are a thermometer, a thermo-couple and a pyrometer. The assembly of the print head and the print head cooler may be provided with one temperature measuring device or alternatively, may be provided with a plurality of temperature measuring devices.

The controller may be a suitable controller, e.g. a computer. The controller may comprise a suitable non-transitory computer-readable medium carrying computer program instructions for instructing a computer to carry out the method according to the present invention.

In an embodiment, the print head cooler further comprises a second surface and a cooling liquid channel provided between the first surface and the second surface for flowing cooling liquid. Hence, the assembly according to this embodiment is configured to perform the method according to an embodiment of the present invention.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic representation of an inkjet printing system;

FIGS. 2A-2C are schematic representations of an inkjet marking device, wherein FIGS. 2A and 2B illustrate an assembly of inkjet heads, and FIG. 2C is a detailed view of a part of the assembly of inkjet heads illustrated in FIGS. 2A and 2B; and

FIG. 3 is a schematic representation of an assembly of a print head and a print head cooler.

### DETAILED DESCRIPTION OF THE PREFERRED EMBODIMEMTS

The present invention will now be described with reference to the accompanying drawings, wherein the same reference numerals have been used to identify the same or similar elements throughout the several views.

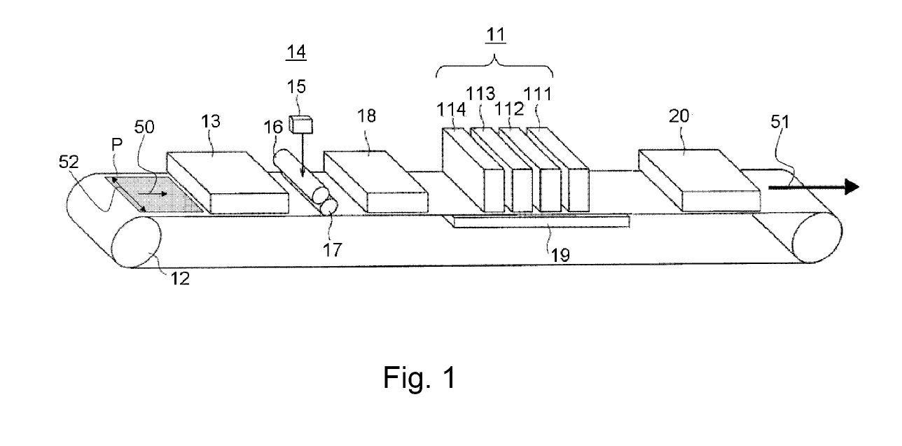

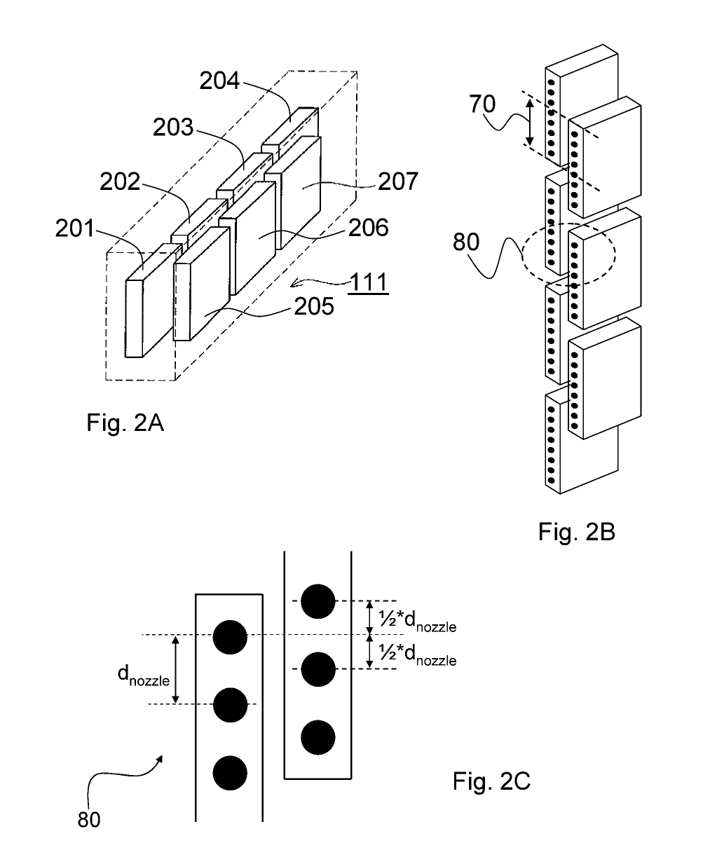

A printing process in which the inks according to the present invention may be suitably used is described with reference to the appended drawings shown in FIG. 1 and FIGS. 2A-2C. FIGS. 1 and 2A-2C are schematic representations of an inkjet printing system and an inkjet marking device, respectively.

FIG. 1 shows a sheet of a receiving medium P. The image receiving medium P may be composed of, e.g. paper, cardboard, label stock, coated paper, plastic, machine coated paper or textile. Alternatively, the receiving medium may be a medium in web form (not shown). The medium P is transported in a direction for conveyance as indicated by arrows 50 and 51 with the aid of transportation mechanism 12. Transportation mechanism 12 may be a driven belt system comprising one (as shown in FIG. 1) or more belts. Alternatively, one or more of these belts may be exchanged for one or more drums. A transportation mechanism may be suitably configured depending on the requirements (e.g. sheet registration accuracy) of the sheet transportation in each step of the printing process and may hence comprise one or more driven belts and/or one or more drums. For a proper conveyance of the sheets of receiving medium, the sheets need to be fixed to the transportation mechanism. The way of fixation is not particularly limited and may be selected from electrostatic fixation, mechanical fixation (e.g. clamping) and vacuum fixation. Of these ways of fixation, vacuum fixation is preferred.

The printing process as described below comprises the steps of media pre-treatment, image formation, drying and fixing, and optionally post treatment.

FIG. 1 shows that the sheet of receiving medium P may be conveyed to and passed through a first pre-treatment module 13, which module may comprise a preheater, for example a radiation heater, a corona/plasma treatment unit, a gaseous acid treatment unit or a combination of any of the above. Optionally and subsequently, a predetermined quantity of the pre-treatment liquid is applied on the surface of the receiving medium P at pre-treatment liquid applying member 14. Specifically, the pre-treatment liquid is provided from storage tank 15 of the pre-treatment liquid to the pre-treatment liquid applying member 14 composed of double rolls 16 and 17. Each surface of the double rolls may be covered with a porous resin material such as sponge. After providing the pre-treatment liquid to auxiliary roll 16 first, the pre-treatment liquid is transferred to main roll 17, and a predetermined quantity is applied on the surface of the receiving medium P. Subsequently, the image receiving medium P on which the pre-treatment liquid was supplied may optionally be heated and dried by drying member 18 which is composed of a drying heater installed at the downstream position of the pre-treatment liquid applying member 14 in order to decrease the quantity of the water content in the pre-treatment liquid to a predetermined range. It is preferable to decrease the water content in an amount of 1.0 weight % to 30 weight % based on the total water content in the provided pre-treatment liquid provided on the receiving medium P.

To prevent the transportation mechanism 12 from being contaminated with pre-treatment liquid, a cleaning unit (not shown) may be installed and/or the transportation mechanism may be comprised of multiple belts or drums as described above. The latter measure prevents contamination of the upstream parts of the transportation mechanism, in particular of the transportation mechanism in the printing region.

### Image Formation

Image formation is performed in such a manner that, employing an inkjet printer loaded with inkjet inks, ink droplets are ejected from the inkjet heads based on digital signals onto a print medium. The inkjet inks may be inkjet inks according to the present invention.

Although both single pass inkjet printing and multi pass (i.e. scanning) inkjet printing may be used for image formation, single pass inkjet printing is preferably used since it is effective to perform high-speed printing. Single pass inkjet printing is an inkjet recording method with which ink droplets are deposited onto the receiving medium to form all pixels of the image by a single passage of a receiving medium underneath an inkjet marking module.

In FIG. 1, 11 represents an inkjet marking module comprising four inkjet marking devices, indicated with 111, 112, 113 and 114, each arranged to eject an ink of a different color (e.g. Cyan, Magenta, Yellow and blacK). The nozzle pitch of each head is, e.g. about 360 dpi. In the present invention, “dpi” indicates a dot number per 2.54 cm.

An inkjet marking device for use in single pass inkjet printing, 111, 112, 113, 114, has a length L of at least the width of the desired printing range, indicated with double arrow 52, the printing range being perpendicular to the media transport direction, indicated with arrows 50 and 51. The inkjet marking device may comprise a single print head having a length of at least the width of said desired printing range. The inkjet marking device may also be constructed by combining two or more inkjet heads, such that the combined lengths of the individual inkjet heads cover the entire width of the printing range. Such a constructed inkjet marking device is also termed a page wide array (PWA) of print heads. FIG. 2A shows an inkjet marking device 111 (112, 113, 114 may be identical) comprising 7 individual inkjet heads (201, 202, 203, 204, 205, 206, 207), which are arranged in two parallel rows, a first row comprising four inkjet heads (201-204) and a second row comprising three inkjet heads (205-207), which are arranged in a staggered configuration with respect to the inkjet heads of the first row. The staggered arrangement provides a page wide array of nozzles that are substantially equidistant in the length direction of the inkjet marking device. The staggered configuration may also provide a redundancy of nozzles in the area where the inkjet heads of the first row and the second row overlap, see the arrow 70 in FIG. 2B. Staggering may further be used to decrease the nozzle pitch (hence increasing the print resolution) in the length direction of the inkjet marking device, e.g. by arranging the second row of inkjet heads such that the positions of the nozzles of the inkjet heads of the second row are shifted in the length direction of the inkjet marking device by half the nozzle pitch, the nozzle pitch being the distance between adjacent nozzles in an inkjet head, d_{nozzle} (see FIG. 2C, which represents a detailed view of 80 in FIG. 2B). The resolution may be further increased by using more rows of inkjet heads, each of which are arranged such that the positions of the nozzles of each row are shifted in the length direction with respect to the positions of the nozzles or all other rows.

In image formation by ejecting an ink, an inkjet head (i.e. print head) employed may be either an on-demand type or a continuous type inkjet head. As an ink ejection system, there may be usable either an electric-mechanical conversion system (e.g., a single-cavity type, a double-cavity type, a bender type, a piston type, a shear mode type, or a shared wall type), or an electric-thermal conversion system (e.g., a thermal inkjet type, or a Bubble Jet type (registered trade name)). Among them, it is preferable to use a piezo type inkjet recording head which has nozzles of a diameter of 30 μm or less in the current image forming method.

FIG. 1 shows that after pre-treatment, the receiving medium P is conveyed to an upstream part of the inkjet marking module 11. Then, image formation is carried out by each color ink ejecting from each inkjet marking device 111, 112, 113 and 114 arranged so that the whole width of the image receiving medium P is covered.

Optionally, the image formation may be carried out while the receiving medium is temperature controlled. For this purpose a temperature control device 19 may be arranged to control the temperature of the surface of the transportation mechanism (e.g. belt or drum) underneath the inkjet marking module 11. The temperature control device 19 may be used to control the surface temperature of the receiving medium P, for example in the range of 10° C. to 100° C. The temperature control device 19 may comprise heaters, such as radiation heaters, and a print head cooler, for example a cold blast, in order to control the surface temperature of the receiving medium within said range. Subsequently and while printing, the receiving medium P is conveyed to the downstream part of the inkjet marking module 11.

### Drying and Fixing

After an image has been formed on the receiving medium, the prints have to be dried and the image has to be fixed onto the receiving medium. Drying comprises the evaporation of solvents, in particular those solvents that have poor absorption characteristics with respect to the selected receiving medium.

FIG. 1 schematically shows a drying and fixing unit 20, which may comprise a heater, for example a radiation heater. After an image has been formed, the print is conveyed to and passed through the drying and fixing unit 20. The print is heated such that solvents present in the printed image, such as water and/or organic co-solvents, evaporate. The speed of evaporation and hence drying may be enhanced by increasing the air refresh rate in the drying and fixing unit 20. Simultaneously, film formation of the ink occurs, because the prints are heated to a temperature above the minimum film formation temperature (MFFT). The residence time of the print in the drying and fixing unit 20 and the temperature at which the drying and fixing unit 20 operates are optimized, such that when the print leaves the drying and fixing unit 20, a dry and robust print has been obtained. As described above, the transportation mechanism 12 in the fixing and drying unit 20 may be separated from the transportation mechanism of the pre-treatment and printing section of the printing apparatus and may comprise a belt or a drum.

### Post Treatment

To increase the print robustness or other properties of a print, such as gloss level, the print may be post treated, which is an optional step in the printing process. For example, the prints may be post treated by laminating the prints. Alternatively, the post-treatment step may comprise a step of applying (e.g. by jetting) a post-treatment liquid onto the surface of the coating layer, onto which the inkjet ink has been applied, so as to form a transparent protective layer on the printed recording medium.

Hitherto, the printing process was described such that the image formation step was performed in-line with the pre-treatment step (e.g. application of an (aqueous) pre-treatment liquid) and a drying and fixing step, all performed by the same apparatus (see FIG. 1). However, the printing process is not restricted to the above-mentioned embodiment. A method in which two or more machines are connected through a belt conveyor, drum conveyor or a roller, and the step of applying a pre-treatment liquid, the (optional) step of drying a coating solution, the step of ejecting an inkjet ink to form an image and the step of drying and fixing the printed image, can be performed. It is, however, preferable to carry out image formation with the above defined in-line image forming method.

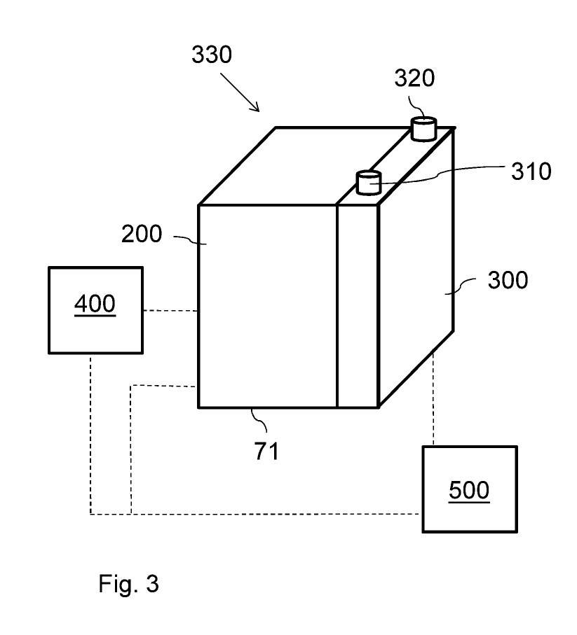

FIG. 3 is a schematic representation of an assembly 330 of a print head 200 and a print head cooler 300. The print head 200 and the print head 300 are positioned against one another. A first surface (not shown) of the print head 200 and a surface of the print head cooler 300 are positioned against one another. Via these surfaces, heat can be exchanged between the print head 200 and the print head cooler 300. The print head cooler 300 is provided with a cooling liquid inlet 310 and a cooling liquid outlet 320. Cooling liquid may flow into the print head cooler 300 via the cooling liquid inlet 310. The cooling liquid may flow out of the print head cooler via the cooling liquid outlet 320. Inside the print head cooler 300, a cooling liquid channel is provided (not shown), which connects the cooling liquid inlet 310 to the cooling liquid outlet 320. The cooling liquid channel may be any known cooling liquid channel. For example. the cooling liquid channel may be a serpentine channel formed inside the print head cooler 300 to maximize the amount of area that the cooling liquid channel occupies inside the print head cooler 300. The cooling liquid may remove heat from the assembly 330. The cooling liquid inlet 310 and the cooling liquid outlet 320 may be connected to a cooling liquid supply (not shown). The cooling liquid supply may comprise, for example a cooling liquid reservoir and a cooling liquid temperature controller, such as a computer.

The print head 200 comprises a nozzle plate 71. In the nozzle plate 71, a plurality of nozzles is provided. The print head 200 is provided with a temperature measuring device 400. The temperature measuring device 400 is configured to measure the temperature of the print head 200. The temperature measuring device may be, e.g. a thermometer or a thermocouple. Please note that, although in FIG. 3 only one temperature measuring device 400 is shown, optionally the print head 200 may be provided with a plurality of temperature measuring devices. The assembly 330 further comprises a controller 500. The controller is operatively connected to the temperature measuring device 400, the print head 200 and the print head cooler 300. The controller 500 may be configured to control operation of the assembly 330. For example, the controller 500 may control operation of the print head cooler 300. The controller 500 may receive data regarding the temperature of the print head from the temperature measuring device 400. Based on the data, the control unit may determine functioning of the print head cooler 300. The controller may be, e.g. a computer.

Detailed embodiments of the present invention are disclosed herein; however, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one skilled in the art to variously employ the present invention in virtually and appropriately detailed structure. In particular, features presented and described in separate dependent claims may be applied in combination and any combination of such claims is herewith disclosed.

Further, the terms and phrases used herein are not intended to be limiting; but rather, to provide an understandable description of the present invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for determining functioning of a print head cooler, the method comprising the steps of:
operating the print head cooler, the print head cooler comprising a first surface in thermal contact with a surface of a print head;
providing a predetermined amount of heat to the print head;
measuring the temperature T of the print head; and
based on the measured temperature T, determining the functioning of the print head cooler,
wherein the predetermined amount of heat is provided by applying at least one non-jetting pulse to a liquid present in the print head.

2. The method according to claim 1, further comprising the steps of:
operating the print head cooler for a predetermined amount of time Δₜ; and
measuring the temperature T of the print head at least twice during the predetermined amount of time Δₜ.

3. The method according to claim 1, wherein the print head cooler further comprises a second surface, and a cooling liquid channel provided between the first surface and the second surface, said method further comprising the step of flowing cooling liquid through the cooling liquid channel.

4. The method according to claim 3, further comprising the step of controlling the temperature and the flow rate of the cooling liquid.

5. An assembly of a print head and a print head cooler,
the print head comprising an ink chamber configured to hold/contain an amount of ink, and an actuator configured to apply a non jetting pulse to the ink in the fluid chamber, and
the print head cooler comprising a first surface that in operation is in thermal contact with a surface of the print head,
wherein the assembly further comprises:
a temperature measuring device configured to measure the temperature of the print head; and
a controller configured to perform the method according to claim 1.

6. The assembly according to claim 5, wherein the print head cooler further comprises a second surface and a cooling liquid channel provided between the first surface and the second surface for flowing cooling liquid therethrough.

7. The assembly according to claim 5, wherein the temperature measuring device is a thermometer.

8. The assembly according to claim 5, wherein the temperature measuring device is a thermos-couple.

9. The assembly according to claim 5, wherein the temperature measuring device is a pyrometer.

10. The assembly according to claim 5, wherein the controller is a computer.
